(19) United States
(12) Patent Application Publication
(10) Pub. No.: US 2025/0392978 A1
(43) Pub. Date: Dec. 25, 2025

(54) METHODS, RADIO NETWORK NODE, AND USER EQUIPMENT OR INTEGRATED ACCESS AND BACKHAUL NODE FOR HANDLING COMMUNICATION

(71) Applicant: Telefonaktiebolaget LM Ericsson (publ), Stockholm (SE)

(72) Inventors: Ritesh Shreevastav, Upplands Väsby (SE); Marco Belleschi, Solna (SE); Gautham Nayak Seetanadi, Stockholm (SE); Behrooz Makki, Pixbo (SE); Victor Farias Monteiro, Fortaleza (BR); Francisco Rafael Marques Lima, Sobral, Ceará (BR); Diego Aguiar Sousa, Fortaleza-Ceará (BR); Darlan Cavalcante Moreira, Fortaleza (BR); Filip Barac, Huddinge (SE)

(21) Appl. No.: 18/703,609

(22) PCT Filed: Oct. 31, 2022
(86) PCT No.: PCT/SE2022/050994

§ 371 Date: Apr. 22, 2024

Related U.S. Application Data
(60) Provisional application No. 63/263,388, filed on Nov. 2, 2021.

(51) Int. Cl. H04W 48/12; H04W 84/04

(52) U.S. Cl. CPC H04W 48/12; H04W 84/047

(57) ABSTRACT

Embodiments herein relate to a method performed by a radio network node for handling communication in a wireless communication network. The radio network node transmits to a UE or an IAB node system information comprising an indication of a cell, controlled by the radio network node, wherein the radio network node is an IAB node, and the indication indicates whether the cell is a mobile cell or not.

### TECHNICAL FIELD

Embodiments herein relate to a radio network node, a user equipment (UE) or an Integrated Access and Backhaul (IAB) node, and methods performed therein regarding wireless communication. Furthermore, a computer program product and a computer-readable storage medium are also provided herein. In particular, embodiments herein relate to handling communication, such as controlling or managing access to an IAB node, in a wireless communication network.

### BACKGROUND

In a typical wireless communication network, user equipment (UE), also known as wireless communication devices, mobile stations, stations (STA) and/or wireless devices, communicate via a Radio Access Network (RAN) with one or more core networks (CN). The RAN covers a geographical area which is divided into service areas or cell areas, with each service area or cell area being served by a radio network node such as an access node, e.g., a Wi-Fi access point or a radio base station (RBS), which in some networks may also be called, for example, a NodeB, a gNodeB, or an eNodeB. The service area or cell area is a geographical area where radio coverage is provided by the radio network node. The radio network node operates on radio frequencies to communicate over an air interface with the UEs within range of the radio network node. The radio network node communicates over a downlink (DL) to the UE, and the UE communicates over an uplink (UL) to the radio network node.

A Universal Mobile Telecommunications System (UMTS) is a third generation telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and UTRAN specifically, and investigate enhanced data rate and radio capacity. In some RANs, e.g., as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3GPP and this work continues in the coming 3GPP releases, such as sixth generation (6G) networks and development of fifth generation (5G) such as New Radio (NR). The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the RAN of an EPS has an essentially “flat” architecture comprising radio network nodes connected directly to one or more core networks.

With the emerging 5G technologies, such as NR, the use of very many transmit- and receive-antenna elements is of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

### Integrated Access and Backhaul (IAB) Overview.

5G networks are being designed and deployed considering a dense deployment of small cells in order to simultaneously serve more UEs with higher throughput and lower delay. However, building from scratch a completely new infrastructure is costly and takes time. Deploying a wireless backhaul is then envisioned to be an economically and technically viable approach to enable flexible and dense network.

This solution was standardized in 3GPP release 16, under the term IAB, to support wireless relaying in next generation (NG)-RAN and has continued in release 17.

IAB is based on a centralized unit (CU)-distributed unit (DU) split that was standardized in release 15. The CU is in charge of the radio resource control (RRC) and the packet data convergence (PCDP) protocol, whereas the DU is in charge of the radio link control (RLC) and multiple access control (MAC). An F1 interface connects the CU and the DU. The CU-DU split facilitates separate physical CU and DU, while also allowing a single CU to be connected to multiple DUs. FIG. 1 shows the basic architecture of IAB.

FIG. 1 shows a single IAB donor connected to the core network. The IAB donor serves three direct IAB child nodes through two collocated DUs at the donor for wireless backhauling. The center IAB node in turn serves two IAB nodes through wireless backhaul. All IAB nodes in FIG. 1 backhauls traffic both related to UEs connected to it, and other backhaul traffic from downstream IAB nodes.

The main components of an IAB architecture are:

IAB Node: A node that allows wireless access to the UEs while also backhauling the traffic to other nodes. The IAB node comprises a DU that provides access to connected UEs. The IAB node also comprises a mobile termination (MT) that connects to other IAB nodes or donors in the uplink direction for backhaul.

IAB Donor: A node that provides UEs an interface to the core network and wireless functionality to other IAB-nodes to backhaul their traffic to the core network.

The defining feature of IAB is the use of wireless spectrum for both access of UEs and backhauling of data through IAB donors. Thus, there needs to be clear separation of access and backhaul resources to avoid interference between them. This separation of access and backhaul resources cannot be handled during network planning due to dynamic nature of IAB. Interference mitigation can consequently be obtained through frequent signal measurements.

In release (Rel) 16, IAB was standardized with basic support for multi-hop multi-path backhaul for directed acyclic graph (DAG) topology, no mesh-based topology was supported. Rel 16 also supports quality of service (QoS) prioritization of backhaul traffic and flexible resource usage between access and backhaul. Current discussions in release 17 are on topology enhancements for IAB with partial migration of IAB nodes for radio link failure (RLF) recovery and load balancing.

Refer to the following for further information about already standardized IAB work
Madapatha, Charitha et al. “On Integrated Access and Backhaul Networks: Current Status and Potentials.” IEEE Open Journal of the Communications Society 1 (January of 2020): 1374-1389
3GPP TS 38.300. v.16.0.0 Section 4.7
3GPP TR 38.874 v.16.0.0 Study on IAB

In release 18, it is expected that the different RAN groups will work towards enhancing functionality of IAB through,
Focus on mobile-IAB/vehicle mounted relays (VMR) providing 5G coverage enhancement to onboard and surrounding UEs
Smart repeaters that build on LTE-repeaters

The initial use cases for mobile-IAB/VMR are expected to be based on 3GPP TR 22.839. One use case of mobile IAB cell is to serve the UEs which are residing in the vehicle with the vehicle mounted relay; IAB solutions. Other relevant use cases for mobile IABs involve a mobile IAB node, also referred to as a nomadic IAB network node, mounted on a vehicle that provides extended coverage. This involves scenarios where additional coverage is required during special events like concerts, during disasters. The mobile IAB node provides access to surrounding UEs while the backhaul traffic from the mobile IAB node is then transmitted wirelessly either with the help of IAB donors or Non-terrestrial networks (NTN). A mobile IAB node may also reduce or even eliminate signal strength loss due to vehicle penetration for UEs that are present in the vehicles.

Advantages of Mobile IAB are
reducing/eliminating the vehicle penetration loss (specially at high frequency),
reducing/eliminating group handover

### SUMMARY

As part of developing embodiments herein one or more problems have been identified. Mobile IAB may be specified in release (Rel)-18. One of the use cases for a Mobile IAB is to provide high speed internet access to UEs inside public transportation like buses, trains, and trams. Thus, while the vehicle is moving, the UEs which are inside should be able to seamlessly connect to high-speed internet and service continuity should be seamless.

One of the problems related with mobile IAB is that UEs outside of the vehicle are allowed to connect to the mobile IAB cell, even if it may deteriorate the quality of experience of UEs inside the vehicle. Thus, the access to Mobile IAB cells in VMR should be used only by the UEs which are onboard and should be restricted to UEs outside of the vehicle. In other words, it needs to be ensured that the outside UEs do not camp on its mobile IAB cell.

Furthermore, if time and frequency resources are not well managed, the UEs outside the vehicle can interfere with the UEs inside. In terms of interference, a problem is that the interference cannot be handled or predicted during the network planning. Then, some mechanisms to have frequent measurements and reports to understand interference situation and, consequently, interference management schemes, may need to be developed. Hence, it is good if the issue of interference or origination/source of interference is mitigated as much as possible.

Interference measurements are relevant.

Depending on the employed time division duplex (TDD) frame pattern, a pedestrian connected to a bus may have an acceptable signal level to a mobile IAB DU, despite bus-induced body loss, but may suffer strong interference depending on the sort of TDD configuration, conflicting or same, with other transmitting nodes. For example, consider a mobile IAB scenario with fixed gNBs acting as IAB donors and with IAB nodes located in buses, where the MT part is deployed outside, e.g., on the rooftop, and the DU part is deployed inside. Also, consider the TDD scheme presented in Table 1. In this scenario, when the MT part of the IAB node transmits in the backhaul in the uplink, e.g., slots 3, 5 and 8, it can cause high interference to pedestrians connected to an IAB node and receiving data from the DU part in the downlink. Remark that, on the one hand, the signal from the DU part suffers attenuation since it is inside the bus and the pedestrian is outside and, on the other hand, the interfering link does not suffer attenuation due to the crossing of the bus body since the MT part is outside the bus.

TABLE 1
Example of a TDD scheme.

| | Slot | Slot | Slot | Slot | Slot | Slot | Slot | Slot | Slot | Slot |
|---|---|---|---|---|---|---|---|---|---|---|
| | 1 | 2 | 3 | 4 | 5 | 6 | 7 | 8 | 9 | 10 |
| IAB Donor | DL | UL | ø | DL | ø | UL | DL | ø | UL | DL |
| Backhaul | DL | ø | UL | DL | UL | ø | ø | UL | ø | DL |
| IAB node | ø | UL | DL | ø | DL | UL | DL | DL | UL | ø |

An object herein is to provide a mechanism to enable communication, e.g., handle or manage signalling, in an efficient manner in a wireless communication network.

According to an aspect the object is achieved by providing a method performed by a radio network node for handling communication in a wireless communication network. The radio network node transmits, to a UE or an IAB node, system information comprising an indication of a cell, controlled by the radio network node, wherein the radio network node is an IAB node, and the indication indicates whether the cell is a mobile cell or not. For example, the indication may indicate whether the cell is a mobile cell or not, e.g., a stationary cell, and/or whether the cell is controlled by an IAB node or not.

According to another aspect the object is achieved by providing a method performed by an IAB node or a UE for handling communication in a wireless communication network. The IAB node or the UE receives, from a radio network node, system information with an indication of a cell controlled by the radio network node, wherein the radio network node is an IAB node, and the indication indicates whether the cell is a mobile cell or not. Thus, the indication indicates whether the cell controlled by the radio network node is a mobile cell or not. The IAB node or the UE further determines whether the IAB node or the UE is allowed to access the cell based on the indication (for example, determines to access the cell based on the indication).

It is furthermore provided herein a computer program product comprising instructions, which, when executed on at least one processor, cause the at least one processor to carry out the methods here, as performed by the IAB node or the UE, or the radio network node, respectively. It is additionally provided herein a computer-readable storage medium, having stored thereon a computer program product comprising instructions which, when executed on at least one processor, cause the at least one processor to carry out the methods herein, as performed by the IAB node or the UE, or the radio network node, respectively.

The object is achieved by providing a radio network node, and a IAB node or a UE configured to perform the methods herein, respectively.

Thus, according to yet another aspect the object is achieved by providing a radio network node for handling communication in a wireless communication network. The radio network node is configured to transmit, to a UE or an IAB node, system information comprising an indication of a cell, controlled by the radio network node, wherein the radio network node is an IAB node, and the indication indicates whether the cell is a mobile cell or not.

According to still another aspect the object is achieved by providing an IAB node or a UE for handling communication in a wireless communication network. The IAB node or the UE is configured to receive, from a radio network node being an IAB node, system information comprising an indication of a cell, controlled by the radio network node, wherein the indication indicates whether the cell is a mobile cell or not. The IAB node or the UE is further configured to determine whether the IAB node or the UE is allowed to access the cell based on the indication.

Embodiments herein disclose adding the indication to the system information for indicating the type of the cell controlled by the radio network node, i.e., whether the cell is a mobile cell or not. For example, it is herein disclosed a design of a dedicated master information block (MIB) for mobile IAB cells. Parameters may be specified such that only UEs and/or IAB nodes which benefit in being in a mobile IAB cell are allowed. An advantage of embodiments herein is to provide a signalling to filter UEs and/or applications that are allowed to camp/access in a mobile cell. As a consequence, another advantage is to mitigate interference by barring certain UEs, traffic types etc. Furthermore, another advantage is to provide a way to avoid ping-pong handovers of UEs outside a vehicle, by not allowing UEs to connect to a mobile IAB cell that is just passing by. By doing this, the system is not overloaded with unnecessary signalling and the outside UEs save power by not performing the transmissions related to the unnecessary handovers.

Moreover, embodiments provide a way to optimize topology adaptation on an IAB network. The indication allows descendent IAB node or UEs to know whether a candidate cell to be its IAB donor is a mobile IAB or not. An IAB node can be blocked to use a mobile IAB node, and thus a mobile cell, as its IAB donor.

Furthermore, the indication may be an IAB cell specific flag in the MIB or system information block (SIB) and may identify not only mobile IAB cells, but any IAB cell. In this case, any IAB node looking for a target IAB donor, may avoid cells that are identified as cells controlled by IAB nodes, i.e., IAB cells.

Embodiments may provide a mobile IAB node, such as the radio network node, to allow camping to either UEs only or both UEs and IAB nodes, thus enabling the radio network node to restrict the depth of the network under the mobile IAB node to one hop, in case UEs only are allowed to camp on the mobile cell. If IAB nodes are also allowed, there will be multiple hops below the mobile IAB node.

Thus, embodiments herein enable communication, e.g., handle or manage signalling, in an efficient manner in a wireless communication network.

### BRIEF DESCRIPTION OF THE DRAWINGS

Embodiments will now be described in more detail in relation to the enclosed drawings, in which:

FIG. 1 is a reference diagram depicting an IAB-architecture according to prior art;

FIG. 2 is a schematic overview depicting a wireless communication network according to embodiments herein;

FIG. 3 is a schematic overview depicting embodiments herein;

FIG. 4 is a combined signalling scheme and flowchart according to some embodiments herein;

FIG. 5 is a schematic flowchart depicting a method performed by a radio network node according to embodiments herein;

FIG. 6 is a schematic flowchart depicting a method performed by a UE or IAB node according to embodiments herein;

FIG. 7 is a block diagram depicting a radio network node according to embodiments herein;

FIG. 8 is a block diagram depicting a UE or IAB node according to embodiments herein;

FIG. 9 illustrates a telecommunication network connected via an intermediate network to a host computer in accordance with some embodiments;

FIG. 10 illustrates a host computer communicating via a base station with a user equipment over a partially wireless connection in accordance with some embodiments;

FIG. 11 illustrates methods implemented in a communication system including a host computer, a base station, and a user equipment in accordance with some embodiments;

FIG. 12 illustrates methods implemented in a communication system including a host computer, a base station, and a user equipment in accordance with some embodiments;

FIG. 13 illustrates methods implemented in a communication system including a host computer, a base station, and a user equipment in accordance with some embodiments; and

FIG. 14 illustrates methods implemented in a communication system including a host computer, a base station, and a user equipment in accordance with some embodiments.

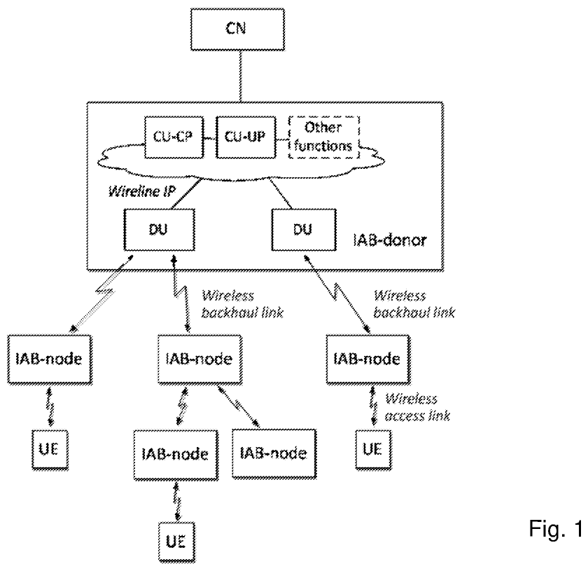

### DETAILED DESCRIPTION

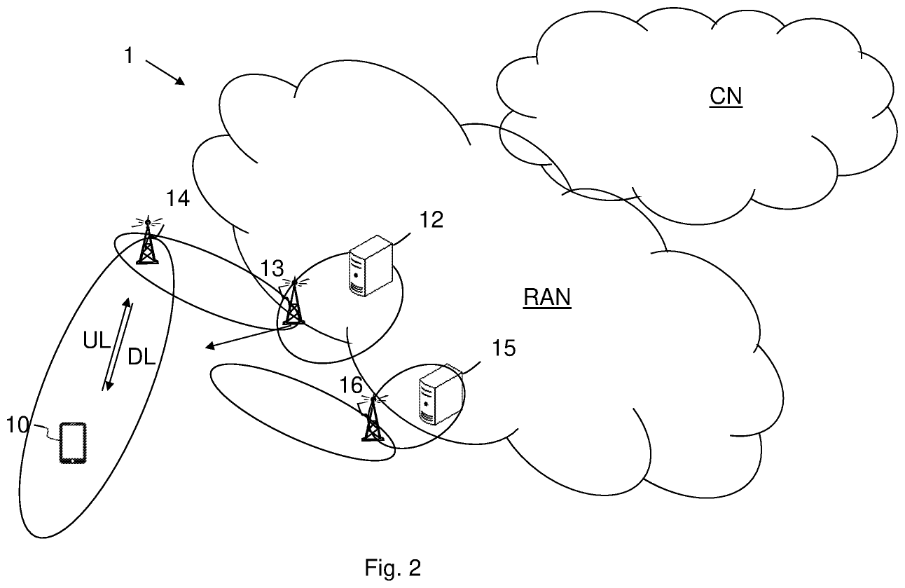

Embodiments herein relate to wireless communication networks in general. FIG. 2 is a schematic overview depicting a wireless communication network 1. The wireless communication network 1 comprises one or more RANs and one or more CNs. The wireless communication network 1 may use one or a number of different technologies. Embodiments herein relate to recent technology trends that are of particular interest in a New Radio (NR) context, however, embodiments are also applicable in further developments of existing wireless communications systems such as LTE or Wideband Code Division Multiple Access (WCDMA).

In the wireless communication network 1, a user equipment (UE) 10, such as a mobile station, a wireless device, a non-access point (non-AP) STA, a STA, and/or a wireless terminal, is communicating via e.g. one or more Access Networks (AN), e.g. RAN, to one or more core networks (CN). It should be understood by the skilled in the art that “UE” is a non-limiting term which means any terminal, wireless communications terminal, user equipment, internet of things (IoT) capable device, Machine Type Communication (MTC) device, Device to Device (D2D) terminal, or node, e.g. smart phone, laptop, mobile phone, sensor, relay, mobile tablets or even a small base station capable of communicating using radio communication with a radio network node within an area served by the radio network node.

The wireless communication network 1 comprises a first radio network node 12 providing radio coverage over an area, e.g., an IAB node such as an IAB-donor node or an IAB-CU, an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), mobility management entity (MME), Access and Mobility Management Function (AMF), a stand-alone access point, or any other network unit or node capable of communicating with a wireless device within a service area served by the first radio network node depending e.g. on a first radio access technology and terminology used. The first radio network node 12 may also be referred to as serving or source node or RAN node. It should be noted that a service area may be denoted as cell, beam, beam group or similar to define an area of radio coverage.

The wireless communication network 1 further comprises a first intermediate radio network node 13 connected in-between the first radio network node 12 and the UE 10. The first intermediate radio network node 13 may be an IAB node, e.g., an access node, antenna unit, radio unit of, e.g., a radio base station such as a gNB, an eNB, a NodeB, a base transceiver station, a radio remote unit, an Access Point Base Station, a base station router, a WLAN access point or an AP STA, a transmission arrangement of a radio base station, a stand-alone access point, or any other network unit or node capable of communicating with a UE within a service area served by the radio network node depending e.g. on a first radio access technology and terminology used. Herein the first intermediate radio network node 13 is a mobile IAB controlling a mobile cell, also referred to as mobile IAB cell or mobile cell. The first intermediate radio network node 13 may also be referred to as the radio network node 13.

The wireless communication network further comprises a second intermediate radio network node 14 connected in-between the first radio network node 12 and the UE 10. The second intermediate radio network node 14 may be connected to the UE 10 directly and may be an egress point. The second intermediate radio network node 14 may be an IAB node, e.g. a radio remote unit (RRU), an access node, antenna unit, radio unit of e.g. a radio base station such as a gNB, an eNB, a NodeB, a base transceiver station, a radio remote unit, an Access Point Base Station, a base station router, a WLAN access point or an AP STA, a transmission arrangement of a radio base station, a stand-alone access point, or any other network unit or node capable of communicating with a wireless device within a service area served by the second intermediate radio network node 14 depending e.g. on a radio access technology and terminology used. It should be noted that a service area may be denoted as a cell, beam, beam group or similar, to define an area of radio coverage.

Furthermore, the wireless communication network 1 comprises a second radio network node 15, e.g. an IAB node such as an IAB-donor node or an IAB-CU, an access node, an access controller, a base station, e.g. a radio base station such as a gNB, an eNB, a NodeB, a base transceiver station, a radio remote unit, an Access Point Base Station, a base station router, a WLAN access point or an AP STA, MME, AMF, a stand-alone access point, or any other network unit or node capable of communicating with a wireless device within a service area served by the radio network node depending e.g. on a radio access technology and terminology used. The second radio network node 15 may be referred to as a RAN node. It should be noted that a service area may be denoted a as cell, beam, beam group or similar, to define an area of radio coverage.

The wireless communication network 1 may further comprise a third intermediate radio network node 16 connected in-between the second radio network node 15 and served UEs. The third intermediate radio network node 16 may be an IAB node, e.g. a RR) such as an access node, antenna unit, radio unit of e.g. a radio base station such as a gNB, an eNB, a NodeB, a base transceiver station, a radio remote unit, an Access Point Base Station, a base station router, a WLAN access point or an AP STA, a transmission arrangement of a radio base station, a stand-alone access point, or any other network unit or node capable of communicating with a wireless device within a service area served by the radio network node depending e.g. on a radio access technology and terminology used. It should be noted that a service area may be denoted as a cell, beam, beam group or similar, to define an area of radio coverage.

In order to perform an initial access or a random access procedure to connect to a cell, the UE 10 may first detect the cell and synchronize with it. For this, the UE 10 may perform a cell search procedure where initial system information (SI) is obtained.

During the cell search, the UE 10 may blindly decode Synchronization Signal Blocks (SSBs) periodically transmitted by the cells. SSBs comprise a Primary Synchronization Signal (PSS), a Secondary Synchronization Signal (SSS) and a Physical Broadcast Channel (PBCH). Firstly, the UE 10 may apply a time domain matched filter to search for one of three possible values of PSS standardized in NR. After finding a value, the UE 10 knows the timing of the SSB and can also find the SSS. Together, PSS and SSS indicate the physical cell ID. After decoding the PSS and SSS, the UE 10 may also decode the PBCH and have access to a MIB. The MIB contains the required parameters, e.g., a CORESET #0 configuration, that allow the UE 10 to decode the System Information Block 1 (SIB1). SIB1 contains information relevant when evaluating if a UE is allowed to access a cell and it defines the scheduling of other SIBs, e.g., SIB9, which contains information related to global positioning system (GPS) time and Coordinated Universal Time (UTC). SIB1 also contains radio resource configuration information that is common for all UEs and barring information applied to the unified access control. For a UE to camp on a cell, it must have acquired the contents of the MIB and SIB1 from that cell.

In the following, it is presented the definition of MIB, SIB1 and SIB9 as defined in TS 38.331 v 16.0.0:

MIB

| -- ASN1START | |
|---|---|
| -- TAG-MIB-START | |
| MIB ::= | SEQUENCE { |
| systemFrameNumber | BIT STRING (SIZE (6)), |
| subCarrierSpacingCommon | ENUMERATED {scs15or60, |
| scs30or120}, | |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, notBarred}, |
| intraFreqReselection | ENUMERATED {allowed, notAllowed}, |
| spare | BIT STRING (SIZE (1)) |

}
-- TAG-MIB-STOP
-- ASN1STOP

MIB field descriptions
cellBarred
Value barred means that the cell is barred, as defined in TS 38.304 [20]. This field is
ignored by IAB-MT.
dmrs-TypeA-Position
Position of (first) DM-RS for downlink (see TS 38.211 [16], clause 7.4.1.1.2) and
uplink (see TS 38.211 [16], clause 6.4.1.1.3).
intraFreqReselection
Controls cell selection/reselection to intra-frequency cells when the highest ranked
cell is barred, or treated as barred by the UE, as specified in TS 38.304 [20]. This field
is ignored by IAB-MT.
pdcch-ConfigSIB1
Determines a common ControlResourceSet (CORESET), a common search space
and necessary PDCCH parameters. If the field ssb-SubcarrierOffset indicates that
SIB1 is absent, the field pdcch-ConfigSIB1 indicates the frequency positions where
the UE may find SS/PBCH block with SIB1 or the frequency range where the network
does not provide SS/PBCH block with SIB1 (see TS 38.213 [13], clause 13).
ssb-SubcarrierOffset
Corresponds to k_{SSB} (see TS 38.213 [13]), which is the frequency domain offset
between SSB and the overall resource block grid in number of subcarriers. (See TS
38.211 [16], clause 7.4.3.1). For operation with shared spectrum channel access (see
37.213 [48]), this field corresponds to k̅_{SSB}, and k_{SSB} is obtained from k̅_{SSB} (see TS
38.211 [16], clause 7.4.3.1); the LSB of this field is used also for deriving the QCL
relation between SS/PBCH blocks as specified in TS 38.213 [13], clause 4.1.
The value range of this field may be extended by an additional most significant bit
encoded within PBCH as specified in TS 38.213 [13].
This field may indicate that this cell does not provide SIB1 and that there is hence no
CORESET#0 configured in MIB (see TS 38.213 [13], clause 13). In this case, the field
pdcch-ConfigSIB1 may indicate the frequency positions where the UE may (not) find
a SS/PBCH with a control resource set and search space for SIB1 (see TS 38.213
[13], clause 13).
subCarrierSpacingCommon
Subcarrier spacing for SIB1, Msg.2/4 and MsgB for initial access, paging and
broadcast SI-messages. If the UE acquires this MIB on an FR1 carrier frequency, the
value scs15or60 corresponds to 15 kHz and the value scs30or120 corresponds to 30
kHz. If the UE acquires this MIB on an FR2 carrier frequency, the value scs15or60
corresponds to 60 kHz and the value scs30or120 corresponds to 120 kHz. For
operation with shared spectrum channel access (see 37.213 [48]), the subcarrier
spacing for SIB1, Msg.2/4 and MsgB for initial access, paging and broadcast SI-
messages is same as that for the corresponding SSB and this field instead is used for
deriving the QCL relation between SS/PBCH blocks as specified in TS 38.213 [13],
clause 4.1.
systemFrameNumber
The 6 most significant bits (MSB) of the 10-bit System Frame Number (SFN). The 4
LSB of the SFN are conveyed in the PBCH transport block as part of channel coding
(i.e. outside the MIB encoding), as defined in clause 7.1 in TS 38.212 [17].

SIB1 message

-- ASN1START
-- TAG-SIB1-START
SIB1 ::= SEQUENCE {

| cellSelectionInfo | SEQUENCE { | |
|---|---|---|
| q-RxLevMin | Q-RxLevMin, | |
| q-RxLevMinOffset | INTEGER (1..8) | OPTIONAL, -- Need |

S

| | | |
|---|---|---|
| q-RxLevMinSUL | Q-RxLevMin | OPTIONAL, -- Need |

R

| | | |
|---|---|---|
| q-QualMin | Q-QualMin | OPTIONAL, -- Need |

S

| | | |
|---|---|---|
| q-QualMinOffset | INTEGER (1..8) | OPTIONAL -- Need |

S

| | |
|---|---|
| } | OPTIONAL, -- Cond |

Standalone

| cellAccessRelatedInfo | CellAccessRelatedInfo, | |
|---|---|---|
| connEstFailureControl | ConnEstFailureControl | OPTIONAL, |

-- Need R

| | | |
|---|---|---|
| si-SchedulingInfo | SI-SchedulingInfo | OPTIONAL, |

-- Need R

| | | |
|---|---|---|
| servingCellConfigCommon | ServingCellConfigCommonSIB | OPTIONAL, |

-- Need R

| | | |
|---|---|---|
| ims-EmergencySupport | ENUMERATED {true} | OPTIONAL, |

-- Need R

| | | |
|---|---|---|
| eCallOverIMS-Support | ENUMERATED {true} | OPTIONAL, |

-- Need R

| | | |
|---|---|---|
| ue-TimersAndConstants | UE-TimersAndConstants | OPTIONAL, |

-- Need R

| uac-BarringInfo | SEQUENCE { | |
|---|---|---|
| uac-BarringForCommon | UAC-BarringPerCatList | OPTIONAL, |

-- Need S

| | | |
|---|---|---|
| uac-BarringPerPLMN-List | UAC-BarringPerPLMN-List | OPTIONAL, |

-- Need S

| | |
|---|---|
| uac-BarringInfoSetList | UAC-BarringInfoSetList, |

uac-AccessCategory1-SelectionAssistanceInfo CHOICE {

| | |
|---|---|
| plmnCommon | UAC-AccessCategory1- |

SelectionAssistance Info,

| | |
|---|---|
| individualPLMNList | SEQUENCE (SIZE (2..maxPLMN)) OF |

UAC-AccessCategory1-SelectionAssistanceInfo

| } | OPTIONAL -- Need S | |
|---|---|---|
| } | OPTIONAL, -- Need R | |
| useFullResumeID | ENUMERATED {true} | OPTIONAL, |

-- Need R

| | | |
|---|---|---|
| lateNonCriticalExtension | OCTET STRING | OPTIONAL, |
| nonCriticalExtension | SIB1-v1610-IEs | OPTIONAL |

}

| SIB1-v1610-IEs ::= | SEQUENCE { | |
|---|---|---|
| idleModeMeasurementsEUTRA-r16 | ENUMERATED{true} | OPTIONAL, |

-- Need R

| | | |
|---|---|---|
| idleModeMeasurementsNR-r16 | ENUMERATED{true} | OPTIONAL, |

-- Need R

| | | |
|---|---|---|
| posSI-SchedulingInfo-r16 | PosSI-SchedulingInfo-r16 | OPTIONAL, |

-- Need R

| | | |
|---|---|---|
| nonCriticalExtension | SIB1-v1630-IEs | OPTIONAL |

}

| | |
|---|---|
| SIB1-v1630-IEs ::= | SEQUENCE { |
| uac-BarringInfo-v1630 | SEQUENCE { |

uac-AC1-SelectAssistInfo-r16 SEQUENCE (SIZE (2..maxPLMN)) OF UAC-AC1-

| | |
|---|---|
| SelectAssistInfo-r16 | OPTIONAL, |

}
-- Need R

| | | |
|---|---|---|
| nonCriticalExtension | SEQUENCE { } | OPTIONAL |

}
UAC-AccessCategory1-SelectionAssistanceInfo ::= ENUMERATED {a, b, c}

| | |
|---|---|
| UAC-AC1-SelectAssistInfo-r16 ::= | ENUMERATED {a, b, c, notConfigured} |

-- TAG-SIB1-STOP
-- ASN1STOP
SIB1 field descriptions

cellSelectionInfo
Parameters for cell selection related to the serving cell.
eCallOverMS-Support
Indicates whether the cell supports eCall over IMS services as defined in TS
23.501 [32]. If absent, eCall over IMS is not supported by the network in the cell.
idleModeMeasurementsEUTRA
This field indicates that a UE that is configured for EUTRA idle/inactive
measurements shall perorm the measurements while camping in this cell and
report availability of these measurements when establishing or resuming a
connection in this cell. If absent, a UE is not required to perform EUTRA
idle/inactive measurements.
idleModeMeasurementsNR
This field indicates that a UE that is configured for NR idle/inactive measurements
shall perform the measurements while camping in this cell and report availability
of these measurements when establishing or resuming a connection in this cell. If
absent, a UE is not required to perform NR idle/inactive measurements.
ims-EmergencySupport
Indicates whether the cell supports IMS emergency bearer services for UEs in
limited service mode. If absent, IMS emergency call is not supported by the
network in the cell for UEs in limited service mode.
q-QualMin
Parameter “Q_{qualmin}” in TS 38.304 [20], applicable for serving cell. If the field is
absent, the UE applies the (default) value of negative infinity for Q_{qualmin}.
q-QualMinOffset
Parameter “Q_{qualminoffset}” in TS 38.304 [20]. Actual value Q_{qualminoffset} = field value
[dB]. If the field is absent, the UE applies the (defualt) value of 0 dB for
Q_{qualminoffset}. Affects the minimum required quality level in the cell.
q-RxLevMin
Parameter “Qᵣₓₗₑᵥₘᵢₙ” in TS 38.304 [20], applicable for serving cell.
q-RxLevMinOffset
Parameter “Q_{rxlevminoffset}” in TS 38.304 [20]. Actual value Q_{rxlevminoffset} = field value *
2 [dB]. If absent, the UE applies the (default) value of 0 dB for Q_{rxlevminoffset}. Affects
the minimum required Rx level in the cell.
q-RxLevMinSUL
Parameter “Qᵣₓₗₑᵥₘᵢₙ” in TS 38.304 [20], applicable for serving cell.
servingCellConfigCommon
Configuration of the serving cell.
uac-AccessCategory1-SelectionAssistanceInfo
Information used to determine whether Access Category 1 applies to the UE, as
defined in TS 22.261 [25]. If plmnCommon is chosen, the UAC-
AccessCategory1-SelectionAssistanceInfo is applicable to all the public land
mobile networks (PLMN) and standalone non public networks (SNPN) in plmn-
IdentityInfoList and npn-IdentityInfoList. If individualPLMNList is chosen, the 1^{st}
entry in the list corresponds to the first network within all of the PLMNs and
SNPNs across the plmn-IdentityList and the npn-IdentityInfoList, the 2^{nd} entry in
the list corresponds to the second network within all of the PLMNs and SNPNs
across the plmn-IdentityList and the npn-IdentityInfoList and so on. If uac-AC1-
SelectAssistInfo-r16 is present, the UE shall ignore the uac-AccessCategory1-
SelectionAssistanceInfo.
uac-AC1-SelectAssistInfo
Information used to determine whether Access Category 1 applies to the UE, as
defined in TS 22.261 [25]. The 1^{st} entry in the list corresponds to the first network
within all of the PLMNs and SNPNs across the plmn-IdentityList and npn-
IdentityInfoList, the 2^{nd} entry in the list corresponds to the second network within
all of the PLMNs and SNPNs across the plmn-IdentityList and the npn-
IdentityInfoList and so on. Value notConfigured indicates that Access Category1
is not configured for the corresponding PLMN/SNPN.
uac-BarringForCommon
Common access control parameters for each access category. Common values
are used for all PLMNs/SNPNs, unless overwritten by the PLMN/SNPN specific
configuration provided in uac-BarringPerPLMN-List. The parameters are specified
by providing an index to the set of configurations (uac-BarringInfoSetList). UE
behaviour upon absence of this field is specified in clause 5.3.14.2.
ue-TimersAndConstants
Timer and constant values to be used by the UE. The cell operating as PCell
always provides this field.
useFullResumeID
Indicates which resume identifier and Resume request message should be used.
UE uses fullI-RNTI and RRCResumeRequest1 if the field is present, or shortI-
RNTI and RRCResumeRequest if the field is absent.

SIB9 information element

-- ASN1START
-- TAG-SIB9-START

| SIB9 ::= | SEQUENCE { | |
|---|---|---|
| timeInfo | SEQUENCE { | |
| timeInfoUTC | INTEGER (0..549755813887), | |
| dayLightSavingTime | BIT STRING (SIZE (2)) | OPTIONAL, |

-- Need R

| | | |
|---|---|---|
| leapSeconds | INTEGER (−127..128) | OPTIONAL, |

-- Need R

| | | |
|---|---|---|
| localTimeOffset | INTEGER (−63..64) | OPTIONAL |

-- Need R

| | |
|---|---|
| } | OPTIONAL, |

-- Need R

| | | |
|---|---|---|
| lateNonCriticalExtension | OCTET STRING | OPTIONAL, |

```
  ...,
    [[
```

| | | |
|---|---|---|
| referenceTimeInfo-r16 | ReferenceTimeInfo-r16 | OPTIONAL |

-- Need R
]]
}
-- TAG-SIB9-STOP
-- ASN1STOP
SIB9 field descriptions
dayLightSavingTime
Indicates if and how daylight-saving time (DST) is applied to obtain the local time. The
semantics are the same as the semantics of the Daylight Saving Time IE in TS 24.501 [23]
and TS 24.008 [38]. The first/leftmost bit of the bit string contains the b2 of octet 3 and the
second bit of the bit string contains b1 of octet 3 in the value part of the Daylight Saving
Time IE in TS 24.008 [38].
leapSeconds
Number of leap seconds offset between GPS Time and UTC. UTC and GPS time are
related i.e. GPS time − leapSeconds = UTC time.
localTimeOffset
Offset between UTC and local time in units of 15 minutes. Actual value = field value * 15
minutes. Local time of the day is calculated as UTC time + localTimeOffset.
timeInfoUTC
Coordinated Universal Time corresponding to the SFN boundary at or immediately after the
ending boundary of the SI-window in which SIB9 is transmitted. The field counts the
number of UTC seconds in 10 ms units since 00:00:00 on Gregorian calendar date 1
Jan. 1900 (midnight between Sunday, Dec. 31, 1899 and Monday, Jan. 1,
1900). See NOTE 1. This field is excluded when determining changes in system
information, i.e. changes of timeInfoUTC should neither result in system information
change notifications nor in a modification of valueTag in SIB1.

Embodiments herein disclose methods to indicate cell type, i.e., mobile cell or not, in the system information, for example, to bar UEs that are not supposed to access to an mobile IAB node such as the first intermediate radio network node 13 hereinafter referred to as the radio network node 13. The radio network node 13 may also allow or disallow IAB nodes to access a mobile cell or a mobile IAB cell. The inclusion in the system information of an indication that a given cell is a mobile cell (or a mobile IAB cell) may be as stated below:
New flag in the MIB to indicate that the cell associated to that MIB is a mobile IAB cell; AND/OR
New MIB specific for mobile IAB cells; AND/OR
New SIB specific for mobile IAB cells.

Furthermore, a criteria, based on the indication included in the system information, may be used by the UEs and/or IAB nodes to determine whether they are allowed to camp on a given cell.

The following should be noted in the context of embodiments of the present disclosure:
The terms “gNB-CU” and “Donor-CU”, “CU-CP,” and “CU” are used interchangeably.
The term “gNB” applies to all variants therein, e.g. “gNB”, “en-gNB,” etc.
The term “a U E/IAB node directly served by the mobile IAB node” refers to a UE/IAB node that is directly connected to the IAB node.
The term “a UE/IAB node is indirectly served by the mobile IAB node” means that the IAB node is an ancestor node to an IAB node that is currently serving the UE or IAB node.

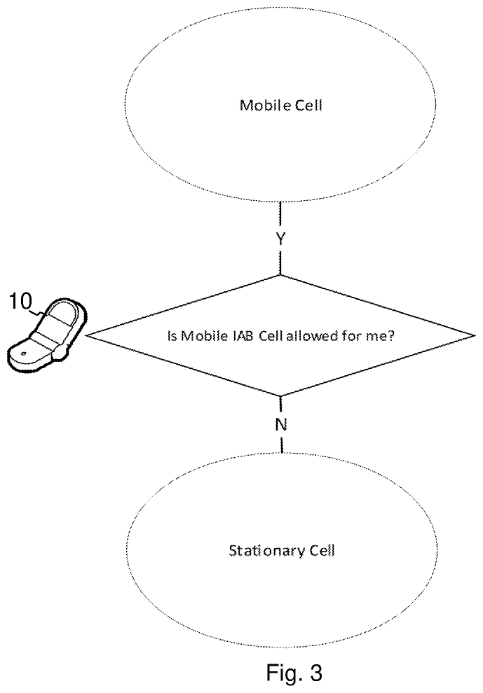

FIG. 3 discloses a schematic overview depicting that the UE 10 receives the SI with the indication and based on the indication the UE 10 either determines to access the mobile cell if it is allowed or determines to access a stationary cell if it is not allowed to access a mobile cell.

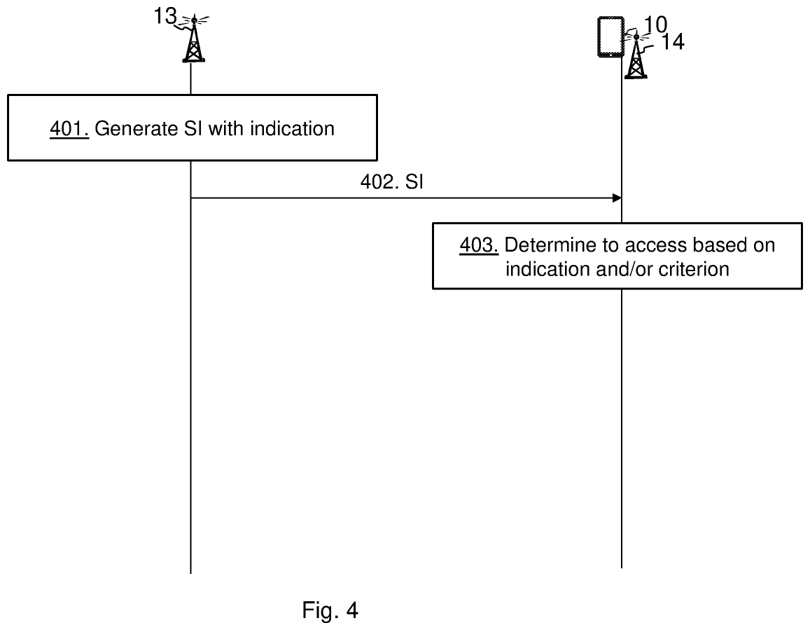

FIG. 4 is a combined signalling scheme and flowchart depicting some embodiments herein.

Action 401. The radio network node 13 may generate SI with the indication indicating type of cell. That is, the indication indicates whether a cell controlled by the radio network node 13 is a mobile cell or a stationary cell.

Action 402. The radio network node 13 transmits the SI with the indication.

Action 403. A network node such as the UE 10 or the second intermediate radio network node 14 may then decide or determine whether it is allowed to access cell based on the indication.

A spare bit in MIB may be replaced by a flag called mobileCell that, if set to TRUE, indicates that the cell transmitting this MIB is a mobile cell, otherwise, if set to FALSE, it is a regular cell, i.e., a stationary cell. The new MIB structure is presented below with the flag underlined.

MIB

-- ASN1START
-- TAG-MIB-START

| | |
|---|---|
| MIB ::= | SEQUENCE { |
| systemFrameNumber | BIT STRING (SIZE (6)), |
| subCarrierSpacingCommon | ENUMERATED {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, notBarred}, |
| intraFreqReselection | ENUMERATED {allowed, notAllowed}, |

[symbol]

mobileCell ENUMERATED {true, false}
}
-- TAG-MIB-STOP
-- ASN1STOP

In a variant, only certain types of network nodes may be allowed to access the cell. For example, only UEs (but not IAB nodes) may be allowed to camp on a mobile IAB cell. In another variant, both UEs and IAB nodes may be allowed to camp on a mobile IAB cell. In the former case, the flag such as mobileCell IE can be defined as follows (a non-limiting example):

mobileCell ENUMERATED {true, false, forUEsOnly,
forUEsandIABNodes}

### New MIB Specific for Mobile IAB Cells.

In another embodiment, a new MIB is designed just for IAB, which will implicitly indicate the cell is a Mobile IAB cell. In such case, information elements cellBarred and intraFreqReselection can be removed which is not as such useful or applicable in the mobile IAB context and other IAB specific information. The proposed specific MIB can be provided as below.

| | |
|---|---|
| MIB-IAB ::= | SEQUENCE { |
| systemFrameNumber | BIT STRING (SIZE (6)), |
| subCarrierSpacingCommon | ENUMERATED {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| accessClass | ENUMERATED {onlyPublicSafety} |
| spare | BIT STRING (SIZE (3)) |

}

A specific MIB for mobile IAB cells would imply legacy UE will not be able to read this and hence they will not attach to such cell. The MIB would be transmitted in a different control region (time/frequency) or different slot and occasion as compared to current MIB. If such behavior is needed, then a specific MIB for mobile IAB cells may be scheduled by the network (NW) otherwise current MIB/SIB is updated to designate that this is a mobile IAB cell.

In a variant of the above embodiment, only UEs (but not IAB nodes) may be allowed to camp on a mobile IAB cell. In another variant, both UEs and IAB nodes can be allowed to camp on a mobile IAB cell. In this case, a new mobileCellDeviceTypesAllowed IE may be defined and inserted in the MIB-IAB shown above. A non-limiting example of the IE:

mobileCellDeviceTypesAllowed ENUMERATED {uEsOnly,
bothUEsandIABNodes}

### New SIB Specific for Mobile IAB Cells.

The access to mobile cell may be restricted only for certain use cases or only for certain UEs. Upon receiving the information in the MIB, or MIB-IAB, indicating that the cell is a mobile IAB cell, the UE 10 may determine whether the cell can be accessed or not. In one example, the UE 10 may only access the mobile IAB cell if it has a subscription, provided by the network, or an access category valid for camping or connecting to a mobile cell. Hence, in case the UE 10 has such a subscription or complies the access category and the cell broadcasts a mobile IAB MIB/SIB, or an indication that this cell is mobile cell, then the UE 10 is allowed to access the cell.

The information of which UEs and for what kind of access the cell can be used may be provided in a specific SIB for IAB or SIB1. The SIB with specific information may provide the necessary information based on which the UEs will know whether they can access that mobile cell. The restrictions to UEs can be, for example, based upon ranging, distance computation from IAB access node, relative speed or pathloss. A specific SIB for mobile IAB is presented below:

| SIB-IAB ::= | SEQUENCE { | |
|---|---|---|
| latitudeSign | ENUMERATED {north, south}, | |
| degreesLatitude | INTEGER (0..8388607), | -- 23 bit field |
| degreesLongitude | INTEGER (−8388608..8388607), | -- 24 bit field |

| | |
|---|---|
| uncertainty | INTEGER (0..127) |
| velocity | INTEGER (0..511), |
| distanceThreshold | INTEGER (0..1023), |
| rsrp-Threshold | INTEGER (0..127), |
| rsrq-Threshold | INTEGER (0..127), |
| accessClass | ENUMERATED {onlyPublicSafety} OPTIONAL, --Need |

ON

| | |
|---|---|
| allowedAccessClass | ENUMERATED {n14, n12} OPTIONAL, --Need ON |
| barreddAccessClass | ENUMERATED {n11, n15} OPTIONAL, --Need ON |
| oneshotMeasurement | ENUMERATED {allowed} OPTIONAL, --Need ON |
| dataVolumeThreshold | ENUMERATED {bytes500, bytes1000} OPTIONAL -- |

Need ON

| | |
|---|---|
| pathID | INTEGER(1..10) |
| movingDirection | ENUMERATED{n, s, w, e, nw, ne, sw, se} |
| supported5QI | SEQUENCE (SIZE (3))OF INTEGER (0..100) |

}

The access to the mobile IAB cell may also be prevented for UEs of a previous release (legacy UEs) which cannot support connection to a mobile IAB cell. Hence, for this reason the radio network node 13 may set the mobile IAB cell as barred, e.g., set a cellBarred flag as barred in the MIB, so that legacy UEs will not access the cell. New UEs instead can connect to a mobile IAB cell. Thus, they can ignore the cellBarred flag, and just determine as per the above embodiments whether this cell is a mobile IAB cell, or not.

The SIB-IAB may also be provided by the static IAB nodes or other non-IAB gNBs during connected mode such as by inserting such message inside the RRC Release message. Hence, if the UE 10 based upon MIB identifies a mobile IAB cell; the UE 10 may not have to read the SIB-IAB and can decide beforehand whether to camp on such cell or not.

Alternatively, or additionally, only UEs (but not IAB nodes) are allowed to camp on a mobile cell. In another variant, both UEs and IAB nodes can be allowed to camp on a mobile IAB cell. In this case, a new mobileCellDeviceTypesAllowed information element (IE) can be defined and inserted in the SIB-IAB shown above. A non-limiting example of the IE:
mobileCellDeviceTypesAllowed ENUMERATED {uEsOnly, bothUEsandIABNodes}

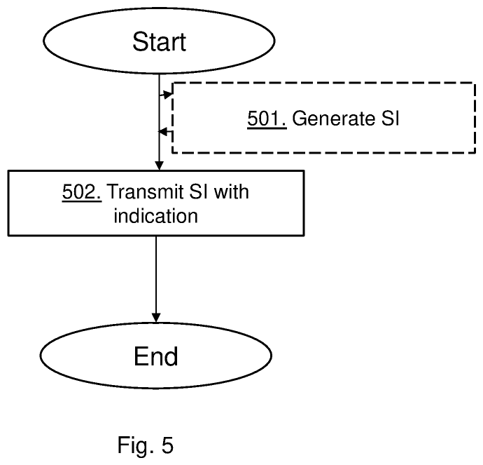

The method actions performed by the radio network node being an IAB node, such as the first intermediate radio network node 13 being, for example, an IAB node controlling a mobile cell, for handling communication in the wireless communication network 1 according to embodiments herein will now be described with reference to a flowchart depicted in FIG. 5. The wireless communication network 1 may comprise one or more nodes relaying data packets between the radio network nodes and the UE 10 and/or intermediate radio network nodes.

Action 501. The radio network node 13 may generate system information, such as a MIB, with the indication.

Action 502. The radio network node 13 transmits to the UE 10 or an IAB node, the SI comprising the indication of the cell, controlled by the radio network node 13, wherein the indication indicates type of cell. That is, the indication indicates whether the cell is a mobile cell or not. The SI may comprise another indication whether one or more types of network nodes are allowed to camp on the cell. The SI may comprise another indication whether the UE 10 and/or the IAB node is allowed to camp on the cell. The indication may comprise a flag indicating whether the cell is a barred cell. The indication may be comprised in a SIB. The SI may further comprise a further indication indicating one or more criteria for which UEs and/or IAB nodes are allowed access to the cell. The indication may be comprised in a MIB or in a MIB designed just for IAB. The one or more criteria may comprise one or more of the following: a subscription, a distance range, a velocity comparison, a movement direction comparison, a path loss threshold, an access class, a traffic type, a data volume threshold, or a path comparison.

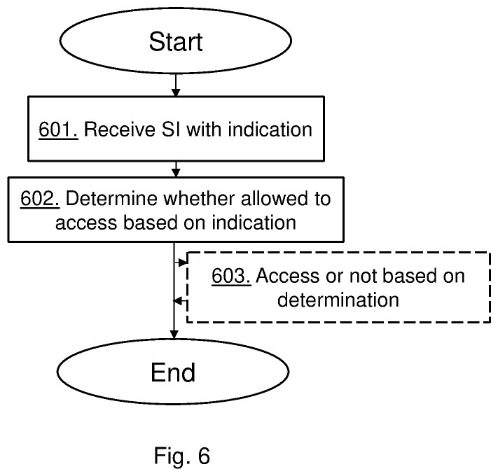

The method actions performed by the network node, such as an IAB node, e.g., the second intermediate radio network node 14, or the UE 10, for handling communication in the wireless communication network 1 according to embodiments herein will now be described with reference to a flowchart depicted in FIG. 6. The wireless communication network may comprise one or more nodes relaying data packets between a central network node and a UE.

Action 601. The IAB node or the UE 10 receives from the radio network node 13 being an IAB node, the system information with the indication of the cell, controlled by the radio network node 13, indicating whether the cell is a mobile cell or not. The indication may comprise the flag indicating whether the cell is a barred cell. The indication may be comprised in a SIB. The indication may be comprised in a MIB or in a MIB designed just for IAB.

Action 602. The IAB node or the UE 10 determines whether the IAB node or the UE 10 is allowed to access the cell based on the indication. This may further be based on one or more criteria. The one or more criteria may comprise one or more of the following: a subscription, a distance range, a velocity comparison, a movement direction comparison, a path loss threshold, an access class, a traffic type, a data volume threshold, or a path comparison. The system information may further comprise another indication whether the UE and/or the IAB node is allowed to camp on the cell; and the UE or the IAB node may also take the other indication into account when determining whether the UE or the IAB node is allowed to access the cell. The system information may further comprise the further indication indicating the one or more criteria for which UEs and/or IAB nodes are allowed access to the cell; and the UE 10 or the IAB node may also take the further indication into account when determining whether the UE or the IAB node is allowed to access the cell.

Action 603. The IAB node or the UE 10 may then access the cell or not based on the determination.

### UE Criteria to be Allowed to Camp on a Mobile IAB Cell.

Based on the received SIB-IAB of a given mobile IAB cell, the UEs can use one of the following criteria to determine whether they are allowed to camp on this cell. In one variant, the below embodiments can be applied to IAB nodes wanting to camp on a mobile IAB cell as well.

### Distance.

In one of the solutions, it is considered that once the UE 10 detects a mobile IAB cell; the UE 10 first estimates a range with the access point of the IAB cell. The range can be based upon distance computation from a location estimation. The mobile IAB constantly performs positioning based upon GPS or other methods and advertises its longitude/latitude via SIB along with the velocity and distance threshold. Then the UEs also perform the positioning computation and then compute d=sqrt [(x2−x1) pow 2+(y2−y1) pow 2]. If the computed distance is within the threshold, the UE 10 camps on such mobile IAB cell.

Alternatively, the UE 10 may be allowed to camp a mobile IAB cell if it is determined that the distance between the UE 10 and a mobile IAB node is constant, while the distance to other static network nodes in the area is changing. For example:
A Mobile IAB (mIAB) arrives to an area. Other static nodes in the area are aware of the presence of the mIAB node, for example, the donor CU informs the gNBs in the area about this, together with the list of cells of the mIAB node.
Network nodes, including the mIAB node exchange the information about UE's distance from the mIAB node and the static nodes.
If the distance between the UE 10 and an mIAB node is constant, while the distance to other static network nodes in the area is changing, the static node serving the UE 10 instructs the UE to camp on the mIAB cell.

### Velocity or Movement.

In another alternative, if the UE 10 is able to compute its velocity and if it matches the velocity of the vehicle, i.e., the radio network node 13, then the UE 10 may camp on such cell. Further, a parameter that discretizes the movement direction, e.g., north, south, east or west (or azimuth), can be used to enhance knowledge regarding UE and mobile IAB cell mobility direction. In this case, if both velocity and movement direction of UE 10 and mobile IAB cell (approximately) match, then the UE 10 is allowed to camp on that mobile IAB cell. Moreover, the UE 10 may also compute time of arrival of SSB beams or compute UE reception (Rx)-transmission (Tx) measurements to assess/compare based upon the threshold parameters whether the cell is to be camped or not.

### Path Loss.

Another parameter to consider is the path loss; this can be based upon signal to interference plus noise ratio (SINR), reference signal received power (RSRP), reference signal received quality (RSRQ) computations. If the detected signals SINR/RSRP/RSRQ are within certain range/threshold, the UE 10 should understand that it may camp on such mobile IAB cell. Specially if the DU is inside the bus, which should be the case, this should give a distinct difference between the in- and out-vehicle UEs.

### Access Class Allowed/Barred.

One more parameter that is considered is the access class; whether the UE 10 is allowed to access a cell depending upon the type of originating traffic. When the radio network node 13 advertises that data traffic with only certain Logical Channel Priority is allowed or only for emergency call or public safety, such as Ultra-reliable low-latency communication (URLLC), relayed traffic is to be conveyed. The UE 10 thus verifies such access class rules and decides whether to camp in the mobile IAB cell or not. In this case, the cell may be nomadic.

For example, below access class can be advertised in the SIB for IAB as these classes are allowed or prohibited.

Access Classes are applicable as follows TS 22.011:

Class 15 — PLMN Staff;
Class 14 — Emergency Services;
Class 13 — Public Utilities (e.g. water/gas suppliers);
Class 12 — Security Services;
Class 11 — For PLMN Use.

### Traffic Type, Data Volume Threshold.

Further traffic type such as periodic or aperiodic (one-shot) may also influence the selection of mobile IAB cell. If the UE 10 has certain UL traffic which is less than certain threshold data volume size and if it is not periodic in nature; the UE 10 could be allowed to access the Mobile IAB cell. Further, the NW may apply different policy where for load balancing the NW may allow UE to always camp on mobile IAB cell if accessible or a UE with low load may still connect the macro base station directly, while the high traffic UEs may connect to through the mobile IAB (vehicle mounted relay). SIB-IAB can also include which 5G QoS Identifiers (5QI) that mobile IAB cell supports

### Path.

The radio network node may also advertise, e.g., as part of the SIB, a path ID associated to the path plan that the mobile cell IAB will do. The UE 10 in turn may be provided by the higher layers with a path identity associated to the path that the UE 10 intends to traverse. For example, the UE 10 may first request the higher layers in the network to access the mobile IAB cell at a specific location and at a given point in time for a certain direction. The radio network node may then provide for such a request a path identity.

In case the provided path identity matches the path ID signaled by the UE 10 in the SIB signaling, then the UE 10 is allowed to access the corresponding mobile IAB cell otherwise it is not allowed to access the cell.

This is applicable for city bus or hop on and hop off bus services where the bus with vehicle mounted relay (VMR) will follow a certain route/path.

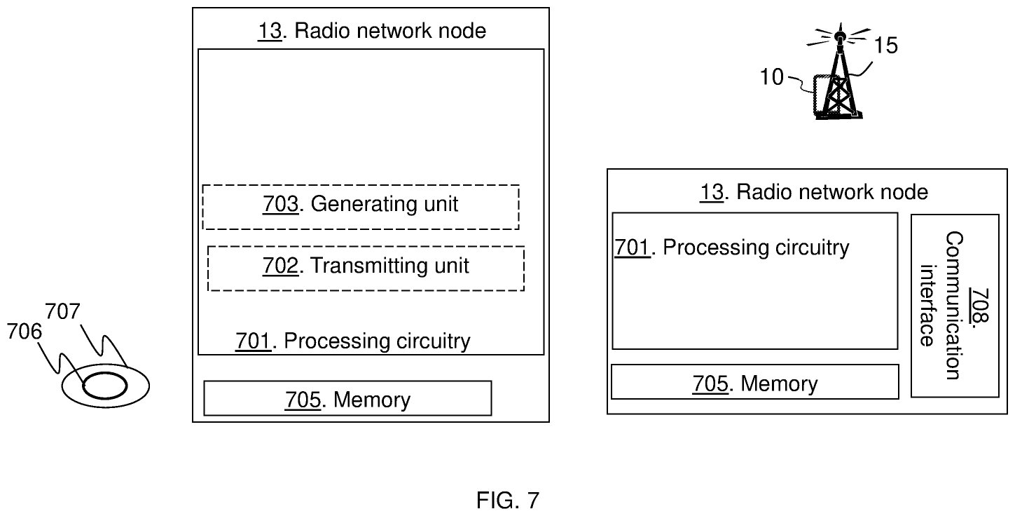

FIG. 7 is a block diagram depicting the radio network node 13 being an IAB node for handling communication in the wireless communication network 1 according to embodiments herein.

The radio network node 13 may comprise processing circuitry 701, e.g., one or more processors, configured to perform the methods herein.

The radio network node 13 may comprise a transmitting unit 702, e.g., a transmitter or a transceiver. The radio network node 13, the processing circuitry 701 and/or the transmitting unit 702 is configured to transmit to the UE 10 or the IAB node, the system information comprising the indication of the cell, controlled by the radio network node 13, wherein the indication indicates whether the cell is a mobile cell or not (and an IAB cell). The system information may further comprise another indication whether the UE and/or the IAB node is allowed to camp on the cell. The indication may comprise a flag indicating whether the cell is a barred cell. The indication may be comprised in a SIB and/or a MIB. The system information may further comprise a further indication indicating the one or more criteria for which UEs or IAB nodes are allowed access to the cell. The indication may be comprised in a MIB designed just for IAB.

The radio network node 13 may comprise a generating unit 703. The radio network node 13, the processing circuitry 701 and/or the generating unit 703 may be configured to generate the system information with the indication. The radio network node 13, the processing circuitry 701 and/or the generating unit 703 may be configured to generate the system information with the other and/or further indication.

The radio network node 13 further comprises a memory 705. The memory 705 comprises one or more units to be used to store data on, such as indications, criteria, MIB, SIBs, SI, measurements, thresholds, data related to nodes, and applications to perform the methods disclosed herein when being executed, and similar. Furthermore, the radio network node may comprise a communication interface 708 such as comprising a transmitter, a receiver and/or a transceiver.

The methods according to the embodiments described herein for the radio network node 13 are respectively implemented by means of, e.g., a computer program product 706 or a computer program, comprising instructions, i.e., software code portions, which, when executed on at least one processor, cause the at least one processor to carry out the actions described herein, as performed by the radio network node 13. The computer program product 706 may be stored on a computer-readable storage medium 707, e.g. a disc, a universal serial bus (USB) stick or similar. The computer-readable storage medium 707, having stored thereon the computer program product, may comprise the instructions which, when executed on at least one processor, cause the at least one processor to carry out the actions described herein, as performed by the radio network node 13. In some embodiments, the computer-readable storage medium may be a transitory or a non-transitory computer-readable storage medium. Thus, embodiments herein may disclose a radio network node for handling communication in a wireless communication network, wherein the radio network node comprises processing circuitry and a memory, said memory comprising instructions executable by said processing circuitry whereby said radio network node is operative to perform any of the methods herein.

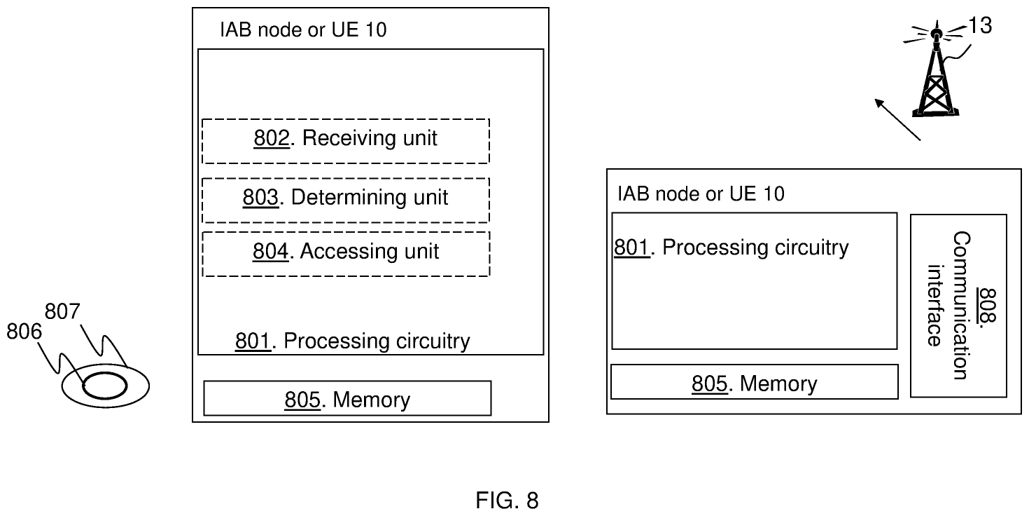

FIG. 8 is a block diagram depicting the UE 10 or the IAB node such as the second intermediate radio network node 14 also referred to as network node 800, for handling communication in a wireless communication network 1 according to embodiments herein.

The UE 10 or the IAB node may comprise processing circuitry 801, e.g., one or more processors, configured to perform the methods herein.

The UE 10 or the IAB node may comprise a receiving unit 802, e.g., a receiver or a transceiver. The UE 10 or the IAB node, the processing circuitry 801, and/or the receiving unit 802 is configured to receive from the radio network node 13, the system information with the indication of the cell, controlled by the radio network node 13, indicating whether the cell is a mobile cell or not. The indication may comprise a flag indicating whether the cell is a barred cell. The indication may be comprised in a SIB. The indication may be comprised in a MIB or in a MIB designed just for IAB.

The UE 10 or the IAB node may comprise a determining unit 803. The network node 800, the processing circuitry 801, and/or the determining unit 803 is configured to determine whether the UE 10 or the IAB node is allowed to access the cell based on the indication. The UE 10 or the IAB node, the processing circuitry 801, and/or the determining unit 803 may be configured to determine whether the UE 10 or the IAB node is allowed to access the cell further based on one or more criteria. The one or more criteria may comprise one or more of the following: the subscription, the distance range, the velocity comparison, the movement direction comparison, the path loss threshold, the access class, the traffic type, the data volume threshold, or the path comparison. The system information may further comprise another indication whether UEs and/or IAB nodes are allowed to camp on the cell; and the UE 10 or the IAB node, the processing circuitry 801, and/or the determining unit 803 may be configured to also take the other indication into account when determining whether to access the cell or not. The system information may further comprise a further indication indicating one or more criteria for which UEs or IAB nodes are allowed access to the cell; and the UE 10 or the IAB node, the processing circuitry 801, and/or the determining unit 803 may be configured to also take the further indication into account when determining whether to access the cell or not.

The UE 10 or the IAB node may comprise an accessing unit 804. The UE 10 or the IAB node, the processing circuitry 801, and/or the accessing unit 804 may be configured to access the cell or not based on the determination.

The UE 10 or the IAB node further comprises a memory 805. The memory 805 comprises one or more units to be used to store data on, such as indications, MIB, SIB, SI, criteria, measurements, thresholds, data related to nodes, and applications to perform the methods disclosed herein when being executed, and similar. Furthermore, the UE 10 or the IAB node may comprise a communication interface 808 such as comprising a transmitter, a receiver and/or a transceiver.

The methods according to the embodiments described herein for the UE 10 or the IAB node are respectively implemented by means of e.g. a computer program product 806 or a computer program, comprising instructions, i.e., software code portions, which, when executed on at least one processor, cause the at least one processor to carry out the actions described herein, as performed by the UE 10 or the IAB node. The computer program product 806 may be stored on a computer-readable storage medium 807, e.g. a disc, a universal serial bus (USB) stick or similar. The computer-readable storage medium 807, having stored thereon the computer program product, may comprise the instructions which, when executed on at least one processor, cause the at least one processor to carry out the actions described herein, as performed by the UE 10 or the IAB node. In some embodiments, the computer-readable storage medium may be a transitory or a non-transitory computer-readable storage medium. Thus, embodiments herein may disclose a UE 10 or an IAB node for handling communication in a wireless communication network, wherein the UE 10 or the IAB node comprises processing circuitry and a memory, said memory comprising instructions executable by said processing circuitry whereby said UE 10 or IAB node is operative to perform any of the methods herein.

### Embodiment 1

A method performed by a radio network node for handling communication in a wireless communication network, wherein the method comprises
transmitting to a network node system information comprising an indication of a cell, controlled by the radio network node, wherein the indication indicates type of cell.

### Embodiment 2

The method according to embodiment 1, wherein the indication indicates whether the cell is a mobile cell or not.

### Embodiment 3

The method according to any of the embodiments 1-2, wherein the system information further comprises another indication whether one or more types of network nodes are allowed to camp on the cell.

### Embodiment 4

The method according to any of the embodiments 1-3, wherein the indication comprises a flag indicating whether the cell is a barred cell.

### Embodiment 5

The method according to any of the embodiments 1-4, wherein the indication is comprised in a SIB.

### Embodiment 6

The method according to any of the embodiments 1-5, wherein the system information further comprises a further indication indicating one or more criteria for which network nodes are allowed access to the cell.

### Embodiment 7

The method according to any of the embodiments 1-6, wherein the indication is comprised in a MIB or in a MIB designed just for IAB.

### Embodiment 8

The method according to any of the embodiments 1-7, further comprising generating the system information with the indication.

### Embodiment 9

A method performed by a network node for handling communication in a wireless communication network, wherein the method comprises
receiving from a radio network node, system information with an indication of the cell, controlled by the radio network node, indicating type of cell; and
determining whether the network node is allowed to access the cell based on the indication.

### Embodiment 10

The method according to embodiment 9, wherein the indication indicates whether the cell is a mobile cell or not.

### Embodiment 11

The method according to any of the embodiments 9-10, wherein determining whether the network node is allowed to access the cell is further based on one or more criteria.

### Embodiment 12

The method according to any of the embodiments 9-11, wherein the one or more criteria comprise one or more of the following: subscription, a distance range, velocity comparison, movement direction comparison, path loss threshold, access class, traffic type, data volume threshold, path comparison.

### Embodiment 13

The method according to any of the embodiments 9-12, further comprising accessing the cell or not based on the determination.

### Embodiment 14

The method according to any of the embodiments 9-13, wherein the system information further comprises another indication whether one or more types of network nodes are allowed to camp on the cell; and the network node also takes the other indication into account when determining whether the network node is allowed to access the cell.

### Embodiment 15

The method according to any of the embodiments 9-14, wherein the indication comprises a flag indicating whether the cell is a barred cell.

### Embodiment 16

The method according to any of the embodiments 9-15, wherein the indication is comprised in a SIB.

### Embodiment 17

The method according to any of the embodiments 9-16, wherein the system information further comprises a further indication indicating one or more criteria for which network nodes are allowed access to the cell; and the network node also takes the further indication into account when determining whether the network node is allowed to access the cell.

### Embodiment 18

The method according to any of the embodiments 9-17, wherein the indication is comprised in a MIB or in a MIB designed just for IAB.

### Embodiment 19

A radio network node for handling communication in a wireless communication network, wherein the radio network node is configured to transmit to a network node system information comprising an indication of a cell, controlled by the radio network node, wherein the indication indicates type of cell.

### Embodiment 20

A network node for handling communication in a wireless communication network, wherein the network node is configured to
receive from a radio network node, system information with an indication of the cell, controlled by the radio network node, indicating type of cell; and
determine whether the network node is allowed to access the cell based on the indication.

In some embodiments, a more general term “radio network node” is used and it can correspond to any type of radio-network node or any network node, which communicates with a wireless device and/or with another network node. Examples of network nodes are NodeB, MeNB, SeNB, a network node belonging to Master cell group (MCG) or Secondary cell group (SCG), base station (BS), multi-standard radio (MSR) radio node such as MSR BS, eNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments, the non-limiting term wireless device or user equipment (UE) is used and it refers to any type of wireless device communicating with a network node and/or with another wireless device in a cellular or mobile communication system. Examples of UEs are IoT capable device, target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles, etc.

Embodiments are applicable to any RAT or multi-RAT systems, where the wireless device receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

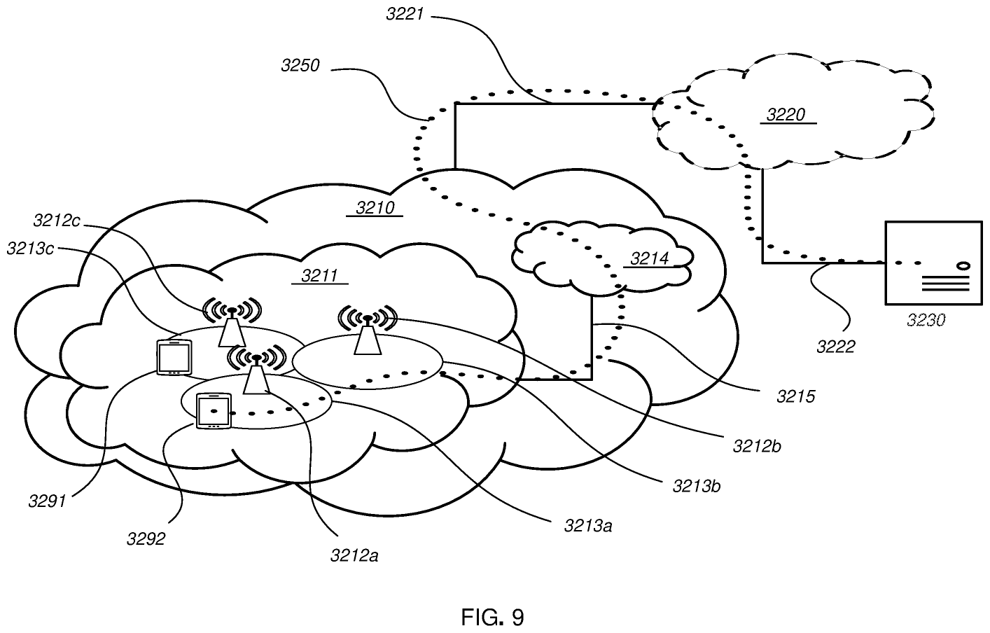

FIG. 9 shows a telecommunication network connected via an intermediate network to a host computer in accordance with some embodiments. With reference to FIG. 9, in accordance with an embodiment, a communication system includes a telecommunication network 3210, such as a 3GPP-type cellular network, which comprises access network 3211, such as a radio access network, and core network 3214. Access network 3211 comprises a plurality of base stations 3212a, 3212b, 3212c, such as NBs, eNBs, gNBs or other types of wireless access points being examples of the radio network node 12 above, each defining a corresponding coverage area 3213a, 3213b, 3213c. Each base station 3212a, 3212b, 3212c is connectable to core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example being examples of the wireless device 10 above, the disclosed embodiments are equally applicable to a situation where a sole UE is in the coverage area or where a sole UE is connecting to the corresponding base station 3212.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider, or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

The communication system of FIG. 9 as a whole enables connectivity between the connected UEs 3291, 3292 and host computer 3230. The connectivity may be described as an over-the-top (OTT) connection 3250. Host computer 3230 and the connected UEs 3291, 3292 are configured to communicate data and/or signalling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded (e.g., handed over) to a connected UE 3291. Similarly, base station 3212 need not be aware of the future routing of an outgoing uplink communication originating from the UE 3291 towards the host computer 3230.

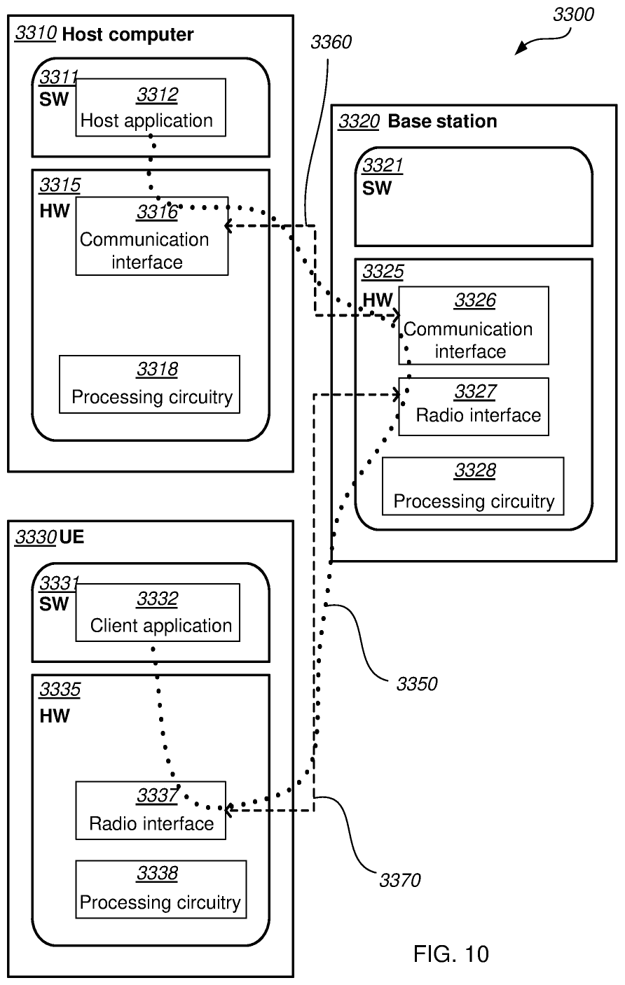

FIG. 10 shows a host computer communicating via a base station and with a user equipment over a partially wireless connection in accordance with some embodiments

Example implementations, in accordance with an embodiment, of the UE, base station and host computer discussed in the preceding paragraphs will now be described with reference to FIG. 10. In communication system 3300, host computer 3310 comprises hardware 3315 including communication interface 3316 configured to set up and maintain a wired or wireless connection with an interface of a different communication device of communication system 3300. Host computer 3310 further comprises processing circuitry 3318, which may have storage and/or processing capabilities. In particular, processing circuitry 3318 may comprise one or more programmable processors, application-specific integrated circuits, field programmable gate arrays or combinations of these (not shown) adapted to execute instructions. Host computer 3310 further comprises software 3311, which is stored in or accessible by host computer 3310 and executable by processing circuitry 3318. Software 3311 includes host application 3312. Host application 3312 may be operable to provide a service to a remote user, such as UE 3330 connecting via OTT connection 3350 terminating at UE 3330 and host computer 3310. In providing the service to the remote user, host application 3312 may provide user data which is transmitted using OTT connection 3350.

Communication system 3300 further includes base station 3320 provided in a telecommunication system and comprising hardware 3325 enabling it to communicate with host computer 3310 and with UE 3330. Hardware 3325 may include communication interface 3326 for setting up and maintaining a wired or wireless connection with an interface of a different communication device of communication system 3300, as well as radio interface 3327 for setting up and maintaining at least wireless connection 3370 with UE 3330 located in a coverage area (not shown in FIG. 10) served by base station 3320. Communication interface 3326 may be configured to facilitate connection 3360 to host computer 3310. Connection 3360 may be direct or it may pass through a core network (not shown in FIG. 10) of the telecommunication system and/or through one or more intermediate networks outside the telecommunication system. In the embodiment shown, hardware 3325 of base station 3320 further includes processing circuitry 3328, which may comprise one or more programmable processors, application-specific integrated circuits, field programmable gate arrays or combinations of these (not shown) adapted to execute instructions. Base station 3320 further has software 3321 stored internally or accessible via an external connection.

Communication system 3300 further includes UE 3330 already referred to. It's hardware 3333 may include radio interface 3337 configured to set up and maintain wireless connection 3370 with a base station serving a coverage area in which UE 3330 is currently located. Hardware 3333 of UE 3330 further includes processing circuitry 3338, which may comprise one or more programmable processors, application-specific integrated circuits, field programmable gate arrays or combinations of these (not shown) adapted to execute instructions. UE 3330 further comprises software 3331, which is stored in or accessible by UE 3330 and executable by processing circuitry 3338. Software 3331 includes client application 3332. Client application 3332 may be operable to provide a service to a human or non-human user via UE 3330, with the support of host computer 3310. In host computer 3310, an executing host application 3312 may communicate with the executing client application 3332 via OTT connection 3350 terminating at UE 3330 and host computer 3310. In providing the service to the user, client application 3332 may receive request data from host application 3312 and provide user data in response to the request data. OTT connection 3350 may transfer both the request data and the user data. Client application 3332 may interact with the user to generate the user data that it provides.

It is noted that host computer 3310, base station 3320 and UE 3330 illustrated in FIG. 10 may be similar or identical to host computer 3230, one of base stations 3212a, 3212b, 3212c and one of UEs 3291, 3292 of FIG. 9, respectively. This is to say, the inner workings of these entities may be as shown in FIG. 10 and independently, the surrounding network topology may be that of FIG. 9.

In FIG. 10, OTT connection 3350 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 3350 is active, the network infrastructure may further take decisions by which it dynamically changes the routing (e.g., on the basis of load balancing consideration or reconfiguration of the network).

Wireless connection 3370 between UE 3330 and base station 3320 is in accordance with the teachings of the embodiments described throughout this disclosure. One or more of the various embodiments improve the performance of OTT services provided to UE 3330 using OTT connection 3350, in which wireless connection 3370 forms the last segment. More precisely, the teachings of these embodiments make it possible to control access to mobile cells. Thereby the data communication, e.g. the handling or managing setup of communication may be performed in an efficient manner.

A measurement procedure may be provided for the purpose of monitoring data rate, latency and other factors on which the one or more embodiments improve. There may further be an optional network functionality for reconfiguring OTT connection 3350 between host computer 3310 and UE 3330, in response to variations in the measurement results. The measurement procedure and/or the network functionality for reconfiguring OTT connection 3350 may be implemented in software 3311 and hardware 3315 of host computer 3310 or in software 3331 and hardware 3333 of UE 3330, or both. In embodiments, sensors (not shown) may be deployed in or in association with communication devices through which OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of OTT connection 3350 may include message format, retransmission settings, preferred routing etc.; the reconfiguring need not affect base station 3320, and it may be unknown or imperceptible to base station 3320. Such procedures and functionalities may be known and practiced in the art. In certain embodiments, measurements may involve proprietary UE signalling facilitating host computer 3310's measurements of throughput, propagation times, latency and the like. The measurements may be implemented in that software 3311 and 3331 causes messages to be transmitted, in particular empty or ‘dummy’ messages, using OTT connection 3350 while it monitors propagation times, errors, etc.

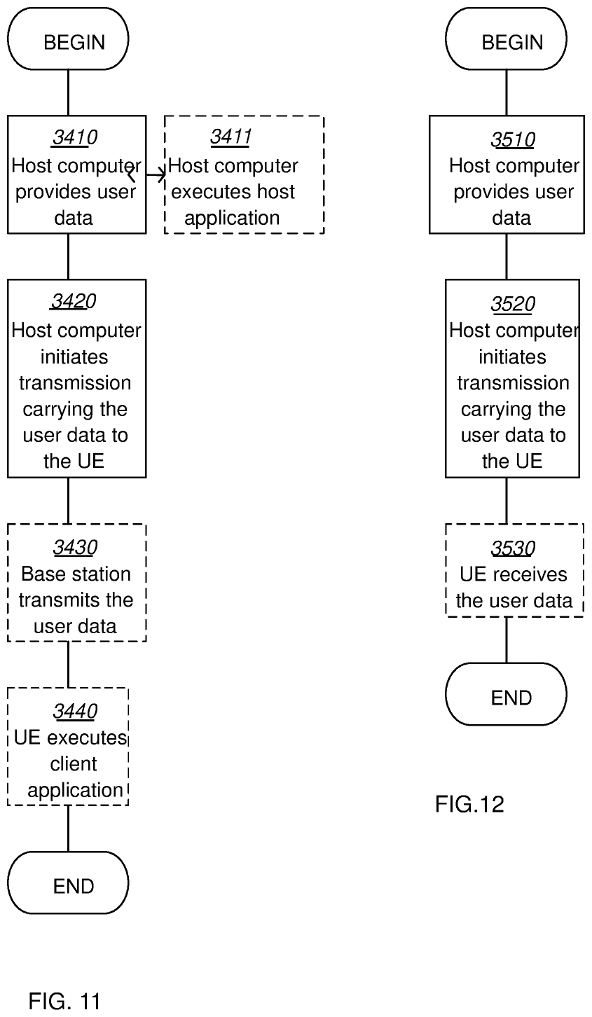

FIG. 11 shows methods implemented in a communication system including a host computer, a base station and a user equipment in accordance with some embodiments.

FIG. 11 is a flowchart illustrating a method implemented in a communication system, in accordance with one embodiment. The communication system includes a host computer, a base station and a UE which may be those described with reference to FIG. 9 and FIG. 10. For simplicity of the present disclosure, only drawing references to FIG. 11 will be included in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated, in accordance with the teachings of the embodiments described throughout this disclosure. In step 3440 (which may also be optional), the UE executes a client application associated with the host application executed by the host computer.

FIG. 12 shows methods implemented in a communication system including a host computer, a base station and a user equipment in accordance with some embodiments.

FIG. 12 is a flowchart illustrating a method implemented in a communication system, in accordance with one embodiment. The communication system includes a host computer, a base station and a UE which may be those described with reference to FIG. 9 and FIG. 10. For simplicity of the present disclosure, only drawing references to FIG. 12 will be included in this section. In step 3510 of the method, the host computer provides user data. In an optional substep (not shown) the host computer provides the user data by executing a host application. In step 3520, the host computer initiates a transmission carrying the user data to the UE. The transmission may pass via the base station, in accordance with the teachings of the embodiments described throughout this disclosure. In step 3530 (which may be optional), the UE receives the user data carried in the transmission.

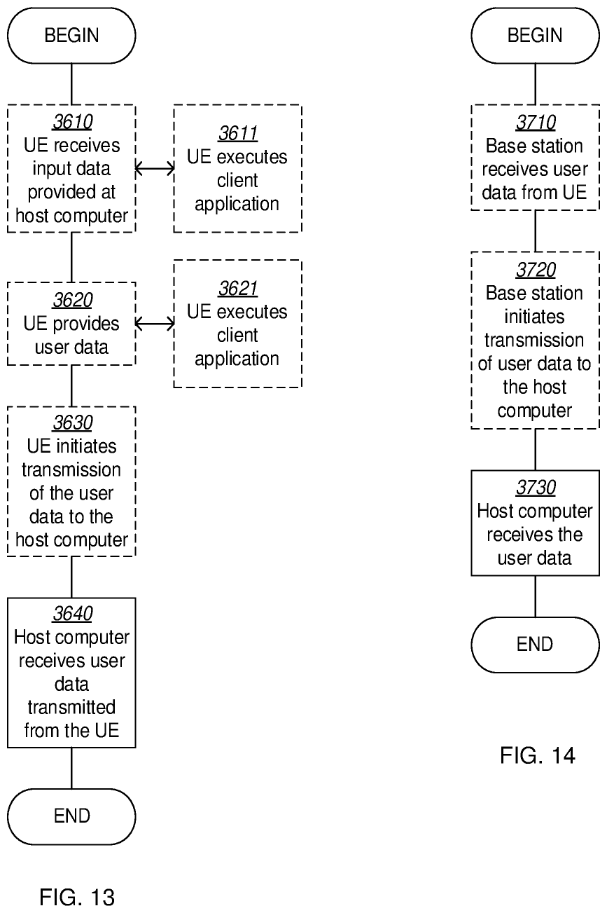

FIG. 13 shows methods implemented in a communication system including a host computer, a base station and a user equipment in accordance with some embodiments.

FIG. 13 is a flowchart illustrating a method implemented in a communication system, in accordance with one embodiment. The communication system includes a host computer, a base station and a UE which may be those described with reference to FIG. 9 and FIG. 10. For simplicity of the present disclosure, only drawing references to FIG. 13 will be included in this section. In step 3610 (which may be optional), the UE receives input data provided by the host computer. Additionally or alternatively, in step 3620, the UE provides user data. In substep 3621 (which may be optional) of step 3620, the UE provides the user data by executing a client application. In substep 3611 (which may be optional) of step 3610, the UE executes a client application which provides the user data in reaction to the received input data provided by the host computer. In providing the user data, the executed client application may further consider user input received from the user. Regardless of the specific manner in which the user data was provided, the UE initiates, in substep 3630 (which may be optional), transmission of the user data to the host computer. In step 3640 of the method, the host computer receives the user data transmitted from the UE, in accordance with the teachings of the embodiments described throughout this disclosure.

FIG. 14 shows methods implemented in a communication system including a host computer, a base station and a user equipment in accordance with some embodiments.

FIG. 14 is a flowchart illustrating a method implemented in a communication system, in accordance with one embodiment. The communication system includes a host computer, a base station and a UE which may be those described with reference to FIG. 9 and FIG. 10. For simplicity of the present disclosure, only drawing references to FIG. 14 will be included in this section. In step 3710 (which may be optional), in accordance with the teachings of the embodiments described throughout this disclosure, the base station receives user data from the UE. In step 3720 (which may be optional), the base station initiates transmission of the received user data to the host computer. In step 3730 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

| Abbreviation | Explanation |
|---|---|
| ACK | (positive) Acknowledgment |
| AUL | Autonomous uplink |
| BLER | Block error rate |
| BWP | Bandwidth Part |
| CAPC | Channel access priority class |
| CBG | Code block group |
| CCA | Clear channel assessment |
| CO | Channel occupancy |
| COT | Channel occupancy time |
| CWS | Contention window size |
| DL | Downlink |
| ED | Energy detection |
| eNB | 4G base station |
| gNB | 5G base station |
| HARQ | Hybrid automatic repeat request |
| IS | In synch |
| LAA | Licensed assisted access |
| LBT | Listen before talk |
| MAC | Medium access control |
| MCOT | Maximum channel occupancy time |
| NACK | Negative acknowledgment |
| NDI | New data indicator |
| NR | 3GPP defined 5G radio access technology |
| NR-U | NR unlicensed |
| OOS | out of synch |
| PCell | Primary cell |
| PCI | Physical cell identity |
| PDCCH | A downlink control channel |
| PDU | Protocol data unit |
| PHICH | Physical channel Hybrid ARQ Indicator Channel |
| PLMN | Public land mobile network |
| PSCell | Primary SCG cell |
| PUCCH | Physical Uplink Control Channel |
| PUSCH | Physical Uplink Shared Channel |
| QCI | QoS class identifier |
| QoS | Quality of service |
| RAT | Radio access technology |
| RLF | Radio link failure |
| RLM | Radio link monitoring |
| RLC | Radio link control |
| RRC | Radio resource control |
| RS | Reference signal |
| SCG | Secondary cell group |
| SDU | Service data unit |
| SMTC | SSB-based measurement timing configuration |
| SpCell | Special cell (PCell or PSCell) |
| SPS | Semi persistent scheduling |
| TTI | Transmission time interval |
| UCI | Uplink Control Information |
| UE | User equipment |
| UL | Uplink |

1. A method performed by a radio network node for handling communication in a wireless communication network, the method comprising:
transmitting to a UE or an Integrated Access and Backhaul, IAB, node, system information comprising an indication of a cell, controlled by the radio network node, wherein the radio network node is an IAB node, and the indication indicates whether the cell is a mobile cell or not.

2. The method according to claim 1, wherein the system information further comprises another indication indicating whether the UE and/or the IAB node is allowed to camp on the cell.

3. The method according to claim 1, wherein the indication comprises a flag indicating whether the cell is a barred cell.

4. The method according to claim 1, wherein the indication is comprised in a system information block, SIB.

5. The method according to claim 1, wherein the system information further comprises a further indication indicating one or more criteria for which UEs or IAB nodes are allowed access to the cell.

6. The method according to claim 5, wherein the one or more criteria comprises one or more of the following: a subscription, a distance range, a velocity comparison, a movement direction comparison, a path loss threshold, an access class, a traffic type, a data volume threshold, or a path comparison.

7. The method according to claim 1, wherein the indication is comprised in a master information block, MIB, or in a MIB designed just for IAB.

8. The method according to claim 1, further comprising generating the system information with the indication.

9. A method performed by a user equipment, UE, or an Integrated Access and backhaul, IAB, node for handling communication in a wireless communication network, the method comprising:
receiving from a radio network node being an IAB node, system information with an indication of a cell, controlled by the radio network node, wherein the indication indicates whether the cell is a mobile cell or not; and
determining whether the UE or the IAB node is allowed to access the cell based on the indication.

10. The method according to claim 9, wherein determining whether the UE or the IAB node is allowed to access the cell is further based on one or more criteria.

11. The method according to claim 10, wherein the one or more criteria comprise one or more of the following: a subscription, a distance range, a velocity comparison, a movement direction comparison, a path loss threshold, an access class, a traffic type, a data volume threshold, or a path comparison.

12. The method according to claim 9, further comprising:
accessing the cell or not based on the determination.

13. The method according to claim 9, wherein the system information further comprises another indication whether the UE and/or the IAB nodes is allowed to camp on the cell; and wherein determining whether the UE or the IAB Node is allowed to access the cell further takes the other indication into account.

14. The method according to claim 9, wherein the indication comprises a flag indicating whether the cell is a barred cell.

15. The method according to claim 9, wherein the indication is comprised in a system information block, SIB, a master information block, MIB, or in a MIB designed just for IAB.

16. The method according to claim 9, wherein the system information further comprises a further indication indicating one or more criteria for which UEs and/or IAB nodes are allowed access to the cell; and wherein determining whether the UE or the IAB node is allowed to access the cell further takes the further indication into account.

17. A radio network node for handling communication in a wireless communication network, the radio network node comprising a communication interface, memory, and processing circuitry associated with the communication interface and memory, wherein the processing circuitry is configured to transmit via the communication interface to a user equipment, UE, or an Integrated Access and Backhaul, IAB, node, system information comprising an indication of a cell, controlled by the radio network node, wherein the radio network node is an IAB node, and the indication indicates whether the cell is a mobile cell or not.

18. The radio network node according to claim 17, wherein the system information further comprises another indication indicating whether the UE and/or the IAB node is allowed to camp on the cell.

19. The radio network node according to claim 17, wherein the indication comprises a flag indicating whether the cell is a barred cell.

20. The radio network node according to claim 17, wherein the indication is comprised in a system information block, SIB.

21.-34. (canceled)
